(19) United States
(12) Patent Application Publication
(10) Pub. No.: US 2022/0290308 A1
(43) Pub. Date: Sep. 15, 2022

(54) REPAIRING DEFECTS IN A GLASS OR GLASS CERAMIC COVERING ON A METAL OR CERAMIC SUBSTRATE INCLUDING THE SUBSTRATE SURFACE

(71) Applicant: OMERAS GMBH OBERFLÄCHENVEREDELUNG UND METALLVERARBEITUNG, Lauter-Bernsbach (DE)

(72) Inventor: Oliver KNAUF, Aue (DE)

(73) Assignee: OMERAS GMBH OBERFLÄCHENVEREDELUNG UND METALLVERARBEITUNG, Lauter-Bernsbach (DE)

(21) Appl. No.: 17/625,563

(22) PCT Filed: Jun. 29, 2020
(86) PCT No.: PCT/EP2020/068256

§ 371 Date: Jan. 7, 2022

(30) Foreign Application Priority Data
Jul. 8, 2019 (EP) 19184905.8

(51) Int. Cl. C23D 5/08; C23D 13/02; C23D 7/00; C23D 5/02; C03C 17/02

(52) U.S. Cl. CPC C23D 5/08; C23D 13/02; C23D 7/00; C23D 5/02; C03C 17/02

(57) ABSTRACT

The invention relates to a method for repairing at least one defect in glass or glass-ceramic coating. In this method, coating material is applied to the at least one defect by a coating method, excess coating material that protrudes is removed, the applied coating material is dried and then baked with the heat input. The invention further relates to a laser repair system for repairing defects, wherein the laser repair system according to the invention comprises at least one exchangeable pivoting device, an exchangeable heat irradiation device, and an energy supply unit.

The invention relates to the repair of at least one defect in a glass or glass-ceramic coating, wherein the glass or the glass-ceramic coating is arranged on a metallic or ceramic substrate, and to the repair of defects on the metallic or ceramic substrate surface. The invention comprises a repair method and a laser repair system for treating defects in enameled objects.

A composite material made of a vitreous inorganic material, also referred to as a glass-ceramic material, comprising a metallic base material, is referred to as enamel. The glass-ceramic material is created through complete or partial melting of mainly oxidic raw materials and a chemical bond with the metallic base material and forms a glass-ceramic coating which is also referred to as an enamel layer. The inorganic preparation produced in this way is applied with additives in one or more layers as a coating on metallic substrates and melted at temperatures above 800° C.

The properties of the enamel are to be matched to the corresponding substrate used and the corresponding purpose. In principle, enamels have a high resistance to corrosion, high wear resistance, chemical neutrality, hygienic, biologically and catalytically inert behavior, insulating properties, and smooth surfaces. The enamels therefore serve as a protective coating for the substrates. Furthermore, enamels are easy to clean, scratch-resistant, and dimensionally stable. Enameled objects such as enameled sheet metals are therefore advantageously used as cladding for rooms or as panels in tunnels or subways. For example, large containers, storage facilities, pipes, signs, industrial parts, consumer goods, cooking vessels, and apparatuses are enameled. In the following, metallic or ceramic substrates having a glass-ceramic coating or an enamel layer are referred to as enameled objects.

A typical method for producing enameled substrates by means of wet milling is described below.

In enamel production, the components of the base enamel and/or the top enamel are finely ground and then melted homogeneously in a standing or continuous furnace. Subsequently, the melt is thermally quenched. The quenching takes place either dry or wet, for example in water. The quenching creates the so-called frit which is also referred to as a glass frit and has vitreous properties.

Enamel formulations, comprising one or more frits, color bodies designed as color oxides, and other additives such as clay, quartz, and/or thickening agents are then finely ground to powder in a ball or planetary mill with the addition of a solvent. In wet milling, the solvent used is usually water or an organic solvent. The suspension of enamel powder in solvent obtained during wet milling is present as an enamel slip and is also referred to below as slip or coating material. Depending on the frits, color oxides, and additives contained in the composition, the suspension can have different colors, degrees of gloss, and properties.

The enamel slip can have different viscosities and can accordingly be designed to be liquid or pasty (paste-like enamel slip). Depending on the composition, it is a base enamel slip or a top enamel slip. Alternatively, the dry enamel powder obtained by dry milling can also be used as powder enamel for further production.

After an optional substrate pretreatment has taken place through various steps such as mechanical and/or chemical cleaning methods and/or drying and/or degreasing and/or preheating, the base enamel slip is then applied as evenly as possible to the substrate using a coating method. The base enamel slip must be completely dry prior to baking thereof to form at least one base enamel layer. Depending on the material of the substrate, baking takes place at a suitable temperature. For example, the temperatures for an aluminum substrate are lower than for a steel substrate. The at least one base enamel layer melts together to form a vitreous coating. The base enamel slip is applied to a substrate by dipping or spraying and baked, in the case of steel or stainless-steel substrates, at approx. 800° C. to 900° C. or in the case of aluminum substrates at approx. 450° C. to 550° C. to form a base enamel layer which, depending on the process, has a thickness of approx. 80 μm to 250 μm.

Subsequently, the application of the top enamel slip is carried out as evenly as possible by means of a coating method with subsequent complete drying and subsequent baking of the top enamel slip to form at least one top enamel layer of approximately 100 μm thickness. In most cases, a plurality of top enamel layers cover the underlying substrate or the underlying base enamel layer. In one embodiment, the top enamel slip is applied to the base enamel by dipping or spraying and baked at 800° C. to 850° C. The total layer thickness of the top enamel layer is in the range from 0 to 1 mm, preferably from 0.05 mm to 0.5 mm.

During the production of enameled objects, but also during assembly or as a result of errors in the use of the same, defects can frequently occur in the enamel layers and/or the underlying substrates.

The enameling process itself is influenced by countless parameters. For example, the substrate materials used, the temperatures and furnace atmosphere, the substances dissolved in the water or the composition and grain size of the enamel powder or enamel slip themselves have a major influence on the production of enameled objects. Any defects that occur are based on deficiencies in the microstructure. These defects are pores, bubbles, cracks, or pinholes, which defects can be traced back to chemically/physically caused outgassing processes. The outgassing mostly comes from the substrates. The escaping gases are mostly carbon oxides and hydrogens, which emerge on the substrate due to the baking process but are blocked and absorbed by the more diffusion-tight enamel layers above, and consequently there are punctiform or relatively large-area defects due to compressive stresses, in particular at the interfaces.

Furthermore, mechanical properties can also be impaired due to insufficient bond strength or adhesion of the enamel with regard to hardness, abrasion, or fracture toughness, which results in the formation of stress lines.

The defects in the enamel layers can result from the subsequent destruction of the coating in the region of production-related defects (e.g. through the eruption of previously closed bubbles or pores or through assembly errors such as impact points or flying sparks) or through the use of the enameled objects for their corresponding function. The defect in tunnel panels or subway panels can also be caused, for example, by falling rocks. At least one enamel layer near the surface bursts away. Faults in assembly, such as grinding work on enameled objects, can also cause corrosion phenomena, which are often favored by the corresponding climatic conditions. The defects usually have a diameter of up to 20 mm, mostly in the range from 0.3 mm to 5 mm. The depth of the defects extends up to 1 mm, but the defects are often between 0.05 mm and 0.5 mm deep.

Although these defects usually appear isolated and scattered, they form points of attack for corrosion phenomena and are also disadvantageous from an aesthetic point of view. In particular in the field of tank construction, a complete system failure or standstill is possible due to a corrosion defect in one of these defect points and therefore represents a high economic and hygienic risk.

Repair methods for defects in enamel layers are already known from the prior art. The parts having defects are often exchanged and replaced with new, defect-free parts or are externally recoated or repaired. Often sealants, plates, or patches are also applied to the defects or the defects are repaired by filling-in.

BR 9 700 234 A discloses a method for repairing minor damage to enameled surfaces. A coating material is applied, the coating material applied for the repair is heated by means of a heat source—in this case a laser—and fused with the surrounding, intact enamel. It is characteristic in this case that the heat input only takes place on the damaged point and the immediate surroundings thereof or on the coating material used for the repair.

WO 2015/055 822 A1 describes a method for producing completely or partially enameled surfaces. For this purpose, the surface is heated locally by means of a magnetic inductor. In addition, the electromagnetic penetration depth is set to a value of less than 1 mm due to the frequency band used by the inductor.

EP 2 269 766 A1 describes a repair method for repairing damaged enameled containers or container components. The method uses a steel plate covered with a tantalum sheet, which steel plate is applied to a damaged point and covers it. This cover is in turn covered or sealed with respect to the enameled wall of the container using a sealing element made of polytetrafluoroethylene (PTFE).

DE 1 947 983 A describes a method for treating a metal object which has a surface coating of enamel which is pre-fired in order to then carry out an electrophoretic repair coating of damaged points of the surface by the precipitation of suitable polymeric coating materials from an aqueous dispersion.

EP 0 407 027 B1 discloses a method for repairing a damaged region of a device made of enameled steel. A repair agent comprising chemical compounds such as metal alkoxides is applied to the damaged region, heated, and solidified into glass using a sol-gel method.

DE 3437620 A1 discloses a method for repairing a defect in an enamel layer. These defects in the form of enamel pores are repaired by pressing a disc of enamel that is ground to complement the defect. This disc is then fixed in a further firing, enamel slip being applied in the region of the edge of the disc before the baking process is carried out. However, the additional firing required to firmly fix the repair enamel disc makes this method unsuitable for mobile repairs on site.

DE 1 696 626 B describes a method for repairing defective enamel layers on cast-iron tubs. Defects that have occurred during enameling, such as pores, bubbles, and pinholes, can now also be eliminated after the enamel has cooled down, without having to reheat and damage the tub due to cracks, bubbles, or pores. After cooling, the tubs are machined at the defect points, completely or partially provided with a new enamel layer, and burned so as to make them smooth. The repair comprises drilling out the defects, applying an enamel suspension to the points to be repaired or sprinkling enamel powder onto the preheated points to be repaired and then burning the repair layer so as to make them smooth. The same enamel is used for the repair as for the original top layer. Since either the entire tub or only the part of the tub to which the new enamel layer was applied is reheated, this is a large-area, imprecise, and complex procedure in which defectless points are melted.

DE 40 21 466 A1 discloses a method for the regeneration of smaller damaged points on the enamel layer in enameled steel tanks. In this case, the damaged point and the adjacent regions are blasted with a blasting agent, in particular corundum, and roughened in order to obtain better adhesion. The damaged points treated in this way are coated with a metallic top layer (and thus not the original material) using a thermal spray process, whereby the surface of the enamel layer is not melted. Crucible spraying, flame, electric arc, detonation, or plasma processes can be used as energy carriers for melting the additive material. Subsequently, the pores of this microporous top layer are sealed by mechanical machining or pore sealers. In this case, too, it is a complex repair method, in particular because of the melting.

Induction-based repair methods are also known. In WO 2015/055822 A1, among other things, the repair of a completely or partially enameled component is disclosed, which repair can be carried out directly at the installation site, i.e. without dismantling and reassembling. The damaged points to be treated in the enamel of industrial parts or consumer goods are mechanically and/or chemically cleaned and contamination is removed. Subsequently, an enamel compound is applied to the point to be repaired and inductively and quickly melted and immediately baked locally. The inductor can be designed as a portable hand-held device and is moved manually over the surface of the workpiece. The size of the inductor is designed to be flexible and adaptable to the corresponding point to be treated. However, there is no thermal pretreatment of the defects, for example by a laser, but purely mechanically or chemically. Furthermore, enameling takes place on an induction basis and not with the use of a laser. Disadvantageously, due to the way the inductor operates due to the eddy current losses generated in the substrate, the method cannot be individually adapted to each material and color composition of the enamel. Rather, due to the consistently different compositions of the material, the enamel layers arranged thereon are heated in a relatively uncontrolled manner starting from the substrate.

Furthermore, the repair methods have significant deficiencies in terms of energy losses that occur, since the energy input is not sufficient with thicker wall thicknesses of the substrates, and a migration of heat is caused in the substrate and the overlying enamel layers. It is not possible to focus the heat beam on a specific point, which means that for reasons of controllability, only thinner wall thicknesses can be considered for this repair method. If the wall thicknesses of the substrates are too low, local overheating of the substrate is likely, which results in both component distortion and stress cracks. On the other hand, higher wall thicknesses require the inductor sources to have a high connection value, which in turn has a negative effect on occupational health and safety in terms of the interaction of the magnetic field with people who, for example, have a pacemaker, making simple use of the repair method problematic. In addition, in the case of greater wall thicknesses, the high connection values required for this are not suitable for mobile repair work.

It would therefore be highly desirable to provide a repair method which is designed so that it can be carried out directly on site and can be individually adjusted to the corresponding material. Furthermore, extensive and costly heating of the treated point should be dispensed with and enameled objects with greater wall thicknesses should also be able to be repaired. In addition, mobile use of the repair method should be ensured.

The object is to provide a repair method which overcomes the disadvantages of the prior art.

In the process, defects including thick enamel layers and the substrates arranged underneath, should be repaired locally, directly, in a time-saving, efficient manner and without energy loss. Formation of cracks and stress lines should be avoided; instead a homogeneous overall impression of the repaired defects should be made possible.

Furthermore, the repair method is to be implemented by means of a transportable and compact device provided for this purpose.

According to the invention, the object is achieved by repairing at least one defect in a glass or glass-ceramic coating according to claim 1, wherein the glass or the glass-ceramic coating is arranged on a metallic or ceramic substrate. Furthermore, the object is achieved according to the invention by repairing defects on the metallic or ceramic substrate surface. Advantageous embodiments of the invention are given in the dependent claims.

A first aspect of the invention relates to a method for repairing at least one defect in a glass or glass-ceramic coating on a metallic or ceramic substrate including the substrate surface, the method according to the invention comprising the following method steps: the application of coating material to the at least one defect by a coating method, the removal of excess coating material that protrudes, the drying of the applied coating material, and the baking of the applied coating material with the heat input. Baking involves the following steps: A first focused, high-energy heat input by laser irradiation with an associated melting of the radiation spot and a subsequent, second defocused, low-energy heat input with controlled continuous cooling of the radiation spot.

Another aspect of the invention relates to a laser repair system for repairing defects in a glass or glass-ceramic coating on a metallic or ceramic substrate including the substrate surface, wherein the laser repair system according to the invention comprises at least one exchangeable pivoting device, an exchangeable heat irradiation device, and an energy supply unit. The laser repair system is detachably arranged on the enamel layer and the heat irradiation device is movably and detachably arranged on the pivoting device. Furthermore, the heat irradiation device comprises at least one exchangeable laser machining head and at least one exchangeable laser. The pivoting device has at least two positions for positioning the heat irradiation device, a first position corresponding to a rest position, and a second position corresponding to a machining position on top of the defect.

In one embodiment, metallic or ceramic substrates are used as substrates, which are also referred to as carrier materials. In a further embodiment, enamelable metals, metallic alloys, or sheet metals such as aluminum alloys, magnesium alloys, low-carbon steel sheets, copper, gold, silver, platinum, stainless steels, cast iron, or glasses are used as substrates. In one embodiment, the enamel layers applied to the substrates as horizontal layers comprise at least one base enamel layer which is in direct contact with the substrate, and at least one top enamel layer which is applied to the base enamel. In one embodiment, enameled objects have a plurality of enamel layers. Due to the adhesive oxides it contains, the base enamel serves to adhere the enamel layer to the substrate surface. In one embodiment, under specific conditions, for example if the substrate is nickel-plated beforehand, the base enamel can be used directly as what is known as direct enamel.

According to the invention, the surface of the enameled object is understood to mean the outermost top enamel layer. The base enamel layer is also referred to below as the base enamel, the top enamel layer is also referred to below as the top enamel.

In one embodiment, a typical composition for a base enamel comprises 34% borax, 28% feldspar, 5% fluorite, 20% quartz, 6% soda, 5% sodium nitrate, and 0.5 to 1.5% each of cobalt, manganese, and nickel oxide.

In one embodiment, a typical composition for a top enamel comprises 23% borax, 52% feldspar, 5% fluorite, 5% quartz, 5% soda, 25% sodium nitrate, 0.5 to 1.5% each of cobalt, manganese and nickel oxide, and 6.5% cryolite. In a further embodiment, about 6 to 10% opacifiers such as tin oxide, titanium silicates, and antimony trioxide as well as color oxides are added in the later production process.

In the context of the invention, the defects are also referred to as defects, defective points, deficiencies, or points to be treated. The defects can appear or penetrate on the surface of the enameled object (mostly in the top enamel), in the enamel layers of the base and/or top enamel, and/or even at least as far as the substrate surface. Furthermore, corrosion phenomena can occur in the substrate or on the substrate surface as defects. In contrast to this, the regions of the enameled object in which there are no defects are referred to as intact.

The repair method according to the invention for one cycle is described below. The individual method steps follow one another directly.

In a preferred embodiment, the repair method has at least one cycle, one cycle comprising the application of coating material (hereinafter also referred to as coating) to the at least one defect and the subsequent baking by a laser (hereinafter also referred to as irradiation). The other pre- and post-treatment steps are not absolutely necessary. In a further embodiment, a combination or repeated execution of the steps in succession is possible in order to bring about the best possible success of the repair.

In one embodiment, detection of the at least one defect takes place before the repair method according to the invention is applied. This test can detect defects and the surface quality of the enamel layer. The extent of the subsequent treatment and the position of the defects on the enameled objects can thereby advantageously be recognized, so that the repair according to the invention can be carried out quickly and in a targeted manner.

The defects in the enamel layers or the underlying substrates can often be recognized with the naked eye, depending on the incidence of light. In a preferred embodiment, detection of at least one defect takes place by means of an optical and/or electrical test. In a preferred embodiment, the optical test comprises a visual inspection. In a preferred embodiment, the electrical test comprises a high-voltage test in accordance with DIN standard DIN EN 14430. In one embodiment, the high-voltage test is carried out in accordance with DIN standard DIN EN 14430 at 20 kV direct current. In an alternative embodiment, the electrical test comprises a low-voltage test in accordance with DIN standard DIN EN ISO 8289.

In a preferred embodiment, the detection of at least one defect is carried out before the application of the coating material with subsequent baking and/or after the application of the coating material with subsequent baking for control purposes.

In a preferred embodiment, a mechanical and/or chemical and/or thermal pretreatment of the at least one defect takes place. In this way, in particular, contaminants on the surface of the at least one defect are advantageously removed. The intact range surrounding the corresponding defect can also be cleaned. The mechanical and/or chemical pretreatment advantageously frees the defect from contamination.

In one embodiment, the mechanical pretreatment comprises grinding and/or milling, which also makes regions of the defect that are remote from the surface accessible, which is particularly advantageous in the case of deeper-lying defects, which can also be present in the substrate. In one embodiment, the chemical pretreatment comprises local etching and/or degreasing of the defect. Furthermore, the pretreatment comprises a subsequent drying of the defect.

In a further embodiment, the pretreatment of the at least one defect comprises a thermal pretreatment in which preheating takes place. In one embodiment, the preheating of the enameled object takes place at a constant temperature, preferably between 20° C. and 30° C. In one embodiment, the thermal pretreatment specifically evaporates contaminants such as surface particles. In one embodiment, the thermal pretreatment is implemented by a thermal laser process using a laser beam. This advantageously creates a defined surface structure of the at least one defect. Furthermore, the thermal laser process is advantageously used to produce a homogeneous starting basis for the at least one defect in a targeted manner. For this purpose, in one embodiment, the defect is defined on a homogeneous standard, where contamination and/or reaction products at the base of the defect are eliminated. In one embodiment, a lower power density is used for the thermal pretreatment by means of a laser than for the subsequent repair method. The heat treatment is carried out on the enameled object starting from

In one embodiment, the at least one defect is filled (also referred to below as coating) with coating material. In one embodiment, finely ground enamel powder or enamel slip is used as the coating material which is introduced into the defect or applied to the defect. In a preferred embodiment, the coating material has the same composition and the same properties as the intact material of the enameled object. In one embodiment, the coating material has the same composition and the same properties as the at least one intact top enamel layer and/or the at least one intact base enamel layer. In an alternative embodiment, the coating material has a composition and properties that differ from the intact material of the enameled object. In a further embodiment, the coating material has the same composition and the same properties or different composition and different properties as the underlying substrate.

In one embodiment, the coating material is applied to the at least one defect using a coating method. In a preferred embodiment, the coating method is selected from a spraying method, a brushing method, a squeegee method, a casting method, a flooding method, a dipping method, a screen-printing method, and/or a spraying method. In one embodiment, the coating method is selected depending on the accessibility of the enameled object to be treated. For example, spraying takes place on easily accessible enameled surfaces, whereas pouring takes place on poorly accessible enameled cavities.

In one embodiment, the coating material is applied to the defect to be repaired via a coating system.

According to the invention, excess coating material located on the surface of the enameled object is removed. Excess coating material is removed mechanically, for example by pulling it off with an object such as a squeegee or a blade. According to the invention, the defect provided with the coating material is then dried. This is done in air or with the supply of heat.

In one embodiment, preheating of the edge regions of the at least one defect takes place by a defocused laser beam. Compared to the focused laser beam, the defocused laser beam irradiates a larger area of the enameled object with a lower overall intensity and consequently a lower power density. When preheating the edge regions with a defocused laser beam, cracks are advantageously avoided at the border regions of the repair site by reducing thermal stresses through slower heating with more even heat distribution and slower cooling.

According to the invention, the coating material applied to the at least one defect is baked with the heat input. According to the invention, baking of the coating material takes place (also referred to as irradiation or melting) by means of the heat input. The heat input has a first focused, high-energy heat input and a second defocused heat input. According to the invention, the first heat input is ensured by a laser and the second heat input by a laser or an inductor. This advantageously results in direct and local healing of the at least one defect.

According to the invention, the baking of the coating material applied to the defect with the heat input comprises two steps.

The baking according to the invention comprises a first, focused, high-energy heat input by laser irradiation with an associated melting of the radiation spot and thus the region of the defect covered by the laser beam. The laser can advantageously be used to achieve rapid scanning over the surface with an associated high energy input for efficient heating of the sample and melting of the defect. However, the associated heat radiation, which can also occur in the intact enamel layers surrounding the defective point and even in the substrate, can cause a formation of cracks in the enamel layers.

The baking process according to the invention therefore comprises a second defocused, low-energy heat input following the first focused, high-energy input of heat, with controlled continuous cooling of the radiation spot. The second defocused heat input has a lower power density than the first focused, high-energy heat input. As a result of the second defocused heat input, a larger area of the enameled object is irradiated with a lower overall intensity and consequently a lower power density compared to the first focused laser beam having a high-energy heat input. Advantageously, the sample heated in the first step is not cooled abruptly, but evenly and slowly.

The second defocused, low-energy heat input is preferably carried out by laser irradiation or inductively.

In one embodiment, as a result of the second defocused, low-energy heat input, the defined or entire region of the defect is irradiated with a defocused laser beam over a relatively large area. During the defocusing of the laser beam, a power reduction in the form of a power-regulated cooling curve takes place. The sample heated by the first focused, high-energy input of heat is advantageously not cooled abruptly, but in a controlled, continuous, and slow manner by the subsequent second defocused, low-energy heat input with a defocused laser beam. Furthermore, the treatment by means of the second defocused, low-energy heat input by means of laser irradiation advantageously results in a local, concentrated, and limited treatment of the treated defect with a deep effect. The slower cooling caused by the defocused laser beam reduces thermal stresses and advantageously prevents the formation of cracks.

In a further embodiment, the second defocused, low-energy heat input causes a large region of the defect to be irradiated inductively over a large area. With induction, the heat is generated by eddy current losses directly in the substrate (not on the surface of the enamel layers or in the enamel layers as is the case with laser treatment) and radiates upwards into the upper enamel layers. Inductive heat treatment is particularly advantageous in the case of larger defects. In one embodiment, the penetration depth of the electromagnetic field is frequency and temperature dependent. The penetration depth of the induction radiation is set in such a way that no more energy input with associated heat dissipation takes place than is required for the individual defect. The controlled heat treatment advantageously limits the heat dissipation into the intact material to a minimum. In one embodiment, the method parameters that can be varied for induction comprise the power and/or the exposure time and/or the sequence of movements of the inductor with regard to speed, direction, and oscillating curve. Advantageously, the inductive irradiation through the second defocused, low-energy heat input results in a large-area and uniform treatment of the defect without the formation of cracks. In one embodiment, the heat input takes place via inductive irradiation through an inductor.

In an alternative embodiment, the second defocused, low-energy heat input takes place by means of laser irradiation and inductively. This combination of laser irradiation and induction advantageously combines the features of laser treatment and induction so that the desired treatment result can be set in a targeted manner and the respective advantages of both methods can be used effectively. Since the heat is generated in the enamel layer by the laser irradiation and the heat is generated in the substrate by the inductive treatment, there is advantageously no warping of the enameled object due to thermal stress on the substrate. Furthermore, the depth effect of the heat input can be combined with a large-area treatment and thus the formation of cracks can advantageously be avoided. The inertia of the materials is also lower, as a result of which the baking can advantageously be regulated more effectively.

In a further alternative embodiment, the defect to be treated is heated purely inductively by the heat input in order to bake the corresponding coating material. For this purpose, the heat irradiation device of the laser repair system comprises at least one inductor.

The treated, repaired defect is cooled down after baking.

In one embodiment, after baking the coating material, the check is carried out as a quality check of the treated, repaired defect. This is done analogously to the detection of the at least one defect. In one embodiment, the check of the treated, repaired defect is carried out using an optical and/or electrical check.

In one embodiment, when the detection of the machined defect determines that the treated, repaired defect has been connected homogeneously to the intact range of the enameled object and/or appears to be free of cracks, the repair method is complete. In a further embodiment, if the detection of the machined defect determines that the treated, repaired defect does not appear homogeneous and/or free of cracks (e.g. due to its depth or its diameter), In a preferred embodiment, individual method steps can be repeated multiple times in succession, depending on the defect and the success of the treatment. Advantageously, individual method parameters can be adapted or corrected as required.

In a preferred embodiment, the finely ground enamel powder or enamel slip designed as a coating material has grain sizes in the range of from 0.35 μm to 160 μm, preferably 0.50 μm to 70 μm, very preferably 18 μm to 50 μm. The finely ground enamel powder or enamel slip of these magnitudes advantageously results in a relatively large-area fusion in the later baking method, which fusion can also take place with a small laser beam diameter. Furthermore, finely ground enamel powder or enamel slip advantageously allows the defects to be better filled with enamel powder or enamel slip and subsequent removal of protruding enamel powder or enamel slip. Due to the fine degree of grinding, the packing density of the enamel powder or enamel slip is also advantageously increased.

In one embodiment, in addition to the chemical composition and the degree of grinding, at least one filler is introduced into the enamel formulation in order to optimize the coating material. The at least one filler is used to produce volume in the defect point to be treated for the repair. Furthermore, the at least one filler advantageously optimizes both the shrinkage and the risk of cracking of the melt in the defect point to be repaired and ensures effective coupling of the laser beam into the defect point to be repaired. In one embodiment, the filler is selected from powdered metal particles, metal powder, metal oxide powder, ceramic and/or metal-ceramic particles.

In one embodiment, in the event of deeper damage to the enameled object, in particular in the event of damage to the substrate or the substrate surface, the defect in the substrate is repaired by engraving down to the substrate. Subsequently, the defect is filled in with the material that was missing. In one embodiment, the material filling of the defect in a metallic substrate takes place through the introduction of the filler. In one embodiment, the material filling of the defect is followed by a fusion process which is preferably implemented by a thermal laser input. Subsequently, by means of the method according to the invention, the treated defect is covered with enamel powder or enamel slip, and this powder or slip is baked with the heat input. The filling of the material by means of the filler and the subsequent process are repeated and carried out until the defect is completely filled. In one embodiment, there is then a multilayer system.

In a preferred embodiment, the laser repair system is detachably arranged on the enameled object. In one embodiment, the laser is movably arranged in a fastening device. The laser can thus advantageously be easy to handle and transport. In one embodiment, the fastening device is designed as a laser repair system. In one embodiment, the laser repair system is placed on the enameled object in the vicinity of the corresponding defect to be treated.

In a preferred embodiment, the laser repair system comprises at least one pivoting device, a heat irradiation device, and an energy supply unit. In a preferred embodiment, the heat irradiation device is movably and detachably arranged on the pivoting device. In one embodiment, the energy supply unit comprises at least one converter and/or one control unit.

In a further preferred embodiment, the laser repair system comprises a coating system which has a supply of coating material. In one embodiment, the coating system is attached to the pivoting device and can be moved by means of running rails and/or guide rails on the pivoting device in the xy direction along the horizontal dimension relative to the enameled object. In one embodiment, the coating system is placed over the defect to be machined during the application of the coating material. In one embodiment, the coating system is designed as a spray system. In one embodiment, the coating system is designed to be exchangeable. The coating method can thus advantageously be adapted to the shape of the enameled object to be treated.

In a further preferred embodiment, the laser repair system comprises a pretreatment device which comprises a pretreatment of the defect before the coating and the subsequent baking of the coating material by the laser. In one embodiment, the pretreatment device comprises mechanical and chemical cleaning units. In one embodiment, the pretreatment device comprises a grinder and/or a milling cutter and/or etching devices. In a further embodiment, the pretreatment device comprises a thermal device. The thermal device serves to supply heat and is designed as a heating plate and/or inductor and/or laser. In one embodiment, the laser used for the pretreatment device is the same as that used for baking the coating material. The thermal device is advantageously also used for drying the applied coating material.

In a further preferred embodiment, the laser repair system comprises a detection system. In one embodiment, the detection system comprises a voltage testing unit, which has a high-voltage testing unit and/or a low-voltage testing unit. In one embodiment, the detection system is used before and/or after the application of the coating material and the subsequent baking of the coating material. In one embodiment, the detection system further comprises a camera system for visual control.

The heat irradiation device can advantageously be exchanged, for example in the case of repairs. In a preferred embodiment, the heat irradiation device comprises at least one laser machining head and at least one laser. In an alternative embodiment, the heat irradiation device comprises at least one inductor with an associated energy supply unit.

In one embodiment, the heat irradiation device comprises at least one laser machining head and at least one laser and at least one inductor with an associated energy supply unit.

In a preferred embodiment, the pivoting device is designed to be placed on the enameled object, the underside of the pivoting device pointing to the surface of the enameled object. In one embodiment, the pivoting device is used to position the heat irradiation device and thus the laser machining head. In a preferred embodiment, the pivoting device has at least two pivoting arms on which a platform is arranged. In a preferred embodiment, the heat irradiation device with attached laser and laser machining head is mounted on the platform. In a further preferred embodiment, the platform is designed to be movable in the xy direction along the horizontal dimension relative to the enameled object by means of the at least two pivoting arms.

In a preferred embodiment, the pivoting device has at least two positions for positioning the heat irradiation device. In one embodiment, the platform is designed to be latched in at least two positions, preferably the corresponding outer possible end positions, by means of the at least two pivoting arms, whereby a geometrically determined positioning of the platform and thus the heat irradiation device with laser and laser machining head is achieved. This positioning with high repetition accuracy advantageously allows for good reproducibility of the repair. Due to the defined positioning of the heat irradiation device, it is stable and fixed in the corresponding position. In a preferred embodiment, the first position of the pivoting device corresponds to the rest position. In a further preferred embodiment, the second position corresponds to the machining position, it being possible for the second position to be arranged exactly on top of the defect.

In one embodiment, the pivoting device is fixed on the surface of the enameled object by means of at least one fastening means. The pivoting device is thus advantageously secured on both flat and obliquely oriented enameled objects. Due to the stable hold of the at least one fastening means, the pivoting device is also fixed upside down on an enameled object, for example when used on damaged ceiling panels. In one embodiment, the at least one fastening means can be released easily and without leaving damage on the surface of the enameled object. In a preferred embodiment, the at least one fastening means is detachably arranged on the underside of the pivoting device. In one embodiment, the at least one fastening means is designed as a magnet and is also referred to as a magnetic base. In one embodiment, the at least one magnet is designed as an electromagnet, i.e. it is magnetized when energized and thus fixed on the enamel layer in the current-carrying state and is non-magnetic and thus detachable from the enamel layer in the de-energized state.

In an alternative embodiment, the at least one fastening means is designed as a vacuum suction device.

In one embodiment, the at least one fastening means is arranged on the pivoting device in such a way that the pivoting device can be positioned at different positions of the defects on the surface of the enameled object, and thus advantageously also machining of defects on the edges of the enameled objects or other regions of difficult access, such as curvatures, can be realized.

In one embodiment, the laser machining head is detachably connected to the heat irradiation device. The laser machining head assumes the same position as the heat irradiation device. The laser machining head can advantageously be exchanged, for example in the case of repairs.

In one embodiment, the laser machining head is the interface of the laser to the workpiece and thus the enameled object. In one embodiment, when the laser is in the second position, part of the repair method according to the invention is carried out by baking the coating material into the defect by means of coupling of the laser beam. The area of the defect that is covered by the laser beam is referred to as the laser beam diameter or radiation spot. In one embodiment, the laser beam at least partially covers the defect. In one embodiment, the laser beam diameter corresponds at least to the diameter of the defect.

In one embodiment, the laser is detachably connected to the heat irradiation device. The laser can advantageously be exchanged, for example in the case of repairs or when using a different type of laser, for example with regard to wavelength and/or signal shape. The type of laser used depends on the defect to be treated, for example in terms of material and absorption capacity. In one embodiment, the penetration depth of the laser radiation is set in such a way that the laser radiation does not penetrate deeper into the material than is necessary to repair the defect, and thus intact material is spared.

In one embodiment, the heat irradiation device has laser protection and/or a spacer. In a further embodiment, the heat irradiation device comprises a fiber-coupled pyrometer and/or a camera system.

In a preferred embodiment, the laser repair system according to the invention is placed on the surface of the enameled object and fixed in the first position thereon by means of the at least one fastening means. In one embodiment, the laser machining head arranged on the heat irradiation device is subsequently moved to the second position by the pivoting device in order to pre-set a mechanical fine positioning of the laser machining head there by means of the camera system and a crosshair attached in the camera system. In an alternative embodiment, the rough positioning of the laser repair system takes place via the crosshairs in the camera system and/or the focusing optics in the laser machining head and the fine positioning is carried out by image recognition software.

In one embodiment, a thermal pretreatment of the defect is then carried out by the laser, as a result of which a defined geometry is achieved for easier subsequent baking of the coating material. In a further embodiment, the laser machining head arranged on the heat irradiation device is then moved back into the first position so that it is not in the way when the defect is filled with coating material. After the coating material has dried and excess coating material has been removed, the laser machining head arranged on the heat irradiation device is subsequently moved to the second position so that the coating material filled into the defect can be baked by heat treatment of the laser. After the baking has taken place, the laser machining head arranged on the heat irradiation device is moved back into the first position, so that the treated point can be checked with regard to the success of the repair. If there are no further deficiencies, the laser repair system can be removed from the surface of the enameled object by loosening the at least one fastening means from the enameled object. If further corrections are necessary, the laser machining head arranged on the heat irradiation device can be moved to the second position again or until success has been achieved in order to thermally treat the treated point again and/or to bake coating material that was additionally applied.

In a preferred embodiment, the heat input of the repair method according to the invention takes place through a laser repair system according to the invention. The laser repair system is placed on the enameled object before the detection of the at least one defect or after the detection of the at least one defect or before the pretreatment of the at least one defect or after the pretreatment of the at least one defect. In a preferred embodiment, the laser repair system according to the invention is removed from the enameled object after completion of the successful repair method according to the invention.

In one embodiment, the laser is understood to be the device with which laser beams are generated. In one embodiment, the method parameters are selected in an adapted manner. In one embodiment, important and variable method parameters of the laser irradiation with regard to heat propagation and focusing comprise parameters such as the materials of the substrate and enamel and/or the pretreatment and/or the selection of the laser type combined with the setting of the wavelength and/or the power density and/or the beam diameter and/or the duration of the irradiation and/or the pulse duration (in the case of lasers operated in a pulsed manner).

In one embodiment, the defect to be treated is irradiated once with the laser and melted, hereinafter also referred to as single irradiation. In a further embodiment, the defect to be treated is irradiated multiple times with the laser and melted, also referred to below as multiple irradiation. In the case of multiple irradiation, the frequency of the pulse (temporal pulse interval) and the number of pulses are also varied.

In one embodiment, the laser is adapted to the material properties such as the absorption capacity of the enamel. In one embodiment, the laser is designed for writing, cutting, and/or surface machining. As a result, an inscription of the enameled object can advantageously take place during the repair.

In one embodiment, gas lasers or solid-state lasers are used as lasers for the repair method according to the invention. In one embodiment, a CO₂ laser is used as the gas laser. In one embodiment, a fiber laser or diode laser or diode-pumped laser is used as the solid-state laser. In a preferred embodiment, an Nd:YAG laser (neodymium-doped yttrium-aluminum-garnet laser) is used. In a further embodiment, any structural type can be used as the laser without being restricted to a specific laser source.

In a preferred embodiment, the laser power is 5 W to 200 W, preferably 5 W to 50 W, very particularly preferably 5 W to 20 W. The laser power is selected depending on the corresponding material composition and in particular the grain size.

In one embodiment, the signal form of the laser is pulsed and/or designed as a continuous wave (cw). In a preferred embodiment, the laser radiation of the at least one defect is carried out by a pulsed solid-state laser. In one embodiment, when the laser is operated in a pulsed manner, the pulse repetition frequency is 1 kHz to 1000 kHz, preferably 20 kHz to 200 kHz. In a preferred embodiment, when the laser is operated in a pulsed manner, the pulse duration is 9 ns to 250 ns, preferably 50 ns to 150 ns.

In one embodiment, the feed rate of the laser machining head is dependent on the size of the defect and is in the range from 5 to 100 mm/sec, preferably in the range from 5 to 40 mm/sec.

In one embodiment, the enamel slip has a degree of absorption of approx. 65% to 50% at a wavelength in the near infrared range of 500 nm to 1070 nm.

In a preferred embodiment, the wavelength of the laser radiation for the repair of the enamel layers is in the near infrared range, preferably from 780 nm to 3 μm, particularly preferably from 800 nm to 1070 nm.

In one embodiment, it is possible in the case of a coating to make engravings in a targeted manner on an enamel layer and to fuse them with the underlying enamel layers. In one embodiment, the laser can be used to create engravings in the surface of the enamel layer. In an alternative embodiment, the inscription of the enamel layer by means of laser engraving is also possible without an associated repair method and/or without an associated laser repair system.

In one embodiment, with the positioning of the enameled object to be treated unchanged, the focal plane is changed relative to the material surface of the enameled object. In one embodiment, for this purpose, the laser repair system is moved in the z-direction along the vertical position relative to the enameled object. In a preferred embodiment, the laser machining head comprises focusing optics for this purpose in order to guide the laser beam between the optical resonator of the laser and the laser machining head. In one embodiment, the focusing optics comprise at least one adjustable mirror and/or at least one articulated arm and/or at least one lens, whereby a radiation spot with variable power density can be automatically adjusted by focusing and defocusing on the defect to be treated. In one embodiment, the focusing optics focus and/or defocus the laser beam on the defect. In this way, it is advantageously possible to switch between a defocused and a focused laser beam, depending on the purpose of the treatment, effectively in terms of time.

In one embodiment, the mirrors of the focusing optics comprise at least one deflection mirror and/or at least one scanner mirror, the mirrors being designed to be pivotable with the aid of a drive. In one embodiment, the drive of the mirrors is designed as a rotary drive, such as, for example, as a galvanometer scanner. In a further embodiment, the scanner drive is designed as an actuator, such as, for example, a piezo drive. In a further embodiment, the focusing optics comprise optical fibers such as glass fibers and/or, whereby an increased flexibility of the system is advantageously possible. This means that the laser can also serve for mobile use.

Alternatively, in order to achieve the laser repair system with a radiation spot that is variable in power density while the positioning is unchanged, the enameled object must be moved up or down accordingly in the z-direction along the vertical position relative to the enameled object.

In one embodiment, the laser repair system is designed to be compact and transportable. In a preferred embodiment, the laser repair system is designed for mobile use as a portable hand-held device for on-site repairs. The laser repair system advantageously has a manageable transportable size such as that of a vacuum cleaner or suitcase with a maximum weight of 20 kg. The laser repair system can also advantageously be carried in the cabin of an aircraft or in a trunk. Due to the compact and transportable design of the laser repair system, it can be moved manually over the surface of the enameled object to be treated. In this way, large-format enameled objects with defects, which objects are difficult to transport, can advantageously be repaired “on site,” i.e. for example on construction sites.

In one embodiment, the repair method according to the invention is carried out on the built-in enameled object which has at least one defect. The mobile laser repair system is therefore flexible enough to treat the relevant points. In an alternative embodiment, the repair method according to the invention takes place on the enameled object having at least one defect, which object is present individually for the repair and/or maintenance and/or before the final assembly.

In one embodiment, by using the laser system for the repair, thicker enamel layers and/or substrates of the enameled objects can also be repaired, since the focusing optics specifically prevent heat migration in the material.

In one embodiment, the repair method for the defects according to the invention takes place in connection with the maintenance of the corresponding enameled objects, whereby the economy is advantageously increased by offering a complete solution. For example, in the case of systems or storage facilities, the downtime is used effectively and the idle time of the systems is reduced to a minimum.

In one embodiment, the repair of the defects according to the invention takes place largely free of cracks, which is advantageously made possible by the local and direct treatment as well as flexibly adjustable passages over the defect. The number of coatings and/or irradiations is variable and also depends, for example, on the depth or the diameter of the defect to be treated. The method parameters for the coating and/or irradiation can be flexibly adapted. Furthermore, gases from the substrate escaping during the repair method according to the invention can advantageously escape to the outside, since the surface in the region of the treated defect is open during the repair method, thus minimizing unwanted pores, bubbles, cracks, or pinholes. The at least one applied base enamel layer and/or top enamel layer is advantageously adapted to the existing intact base enamel layer and/or top enamel layer in terms of color and/or surface properties, since the base enamel and/or top enamel used for repair have the same composition and properties as the intact base enamel and/or top enamel. This advantageously avoids the formation of cracks or the formation of stress lines due to matching material properties, and the repaired point is also not visible.

In one embodiment, the repair method according to the invention ensures a connection of the enamel layers to the substrate and thus a stable adhesive strength. The repaired defects thus advantageously have a homogeneous overall impression. Furthermore, the improved adhesion advantageously reduces the enamel layers from flaking off the substrate, even at corners or edges. This advantageously ensures a high product quality of the repaired enameled object.

Due to the flexibility of the method parameters of the thermal radiation used in terms of heat propagation and focusing by setting, for example, wavelength, power density, and pulse duration, an individual adaptation to the properties of the enameled objects such as material composition or wall thicknesses of the substrates is advantageously possible. The repair method according to the invention thus advantageously ensures an energy- and time-efficient treatment, since the method parameters are specifically selected and controlled. Furthermore, the melting and baking process can advantageously be carried out in an energy-saving manner through the targeted energy input by the laser, in contrast to a furnace that heats the entire enameled object globally and over a large area.

In one embodiment, the repair method according to the invention can be used directly after the manufacture of the enameled objects as a quality check and/or directly on site at the construction site or assembly site.

In one embodiment, the repair method according to the invention is applied to enameled containers or storage facilities such as silos or storage tanks. The silos can be used as storage facilities for agricultural products, drinking water, wastewater, as well as artificial fish breeding tanks and for use in biogas technology. The silos can have diameters of up to 60 m and heights of up to 30 m. Silos of this size are made up of panels and are usually assembled at the destination. Often, silos designed as drinking water reservoirs are also used in desert regions, accompanied by extreme temperature and air conditions. Furthermore, the on-site assembly, for example during grinding, can result in damage and defects in the enameled storage facilities, which can result in corrosion. If defects occur, these defects can therefore usually only be repaired on site due to the size dimensions.

Furthermore, large-area enameled panels in tunnels or on subways can have defects, for example due to stone chips.

Defects in enameled cladding or enameled objects in rooms, large containers, storage facilities, pipes, signs, industrial parts, consumer goods, cooking vessels, and apparatuses such as, for example, stirred containers can be repaired with the method according to the invention. By using optical fibers, the laser beam can also be advantageously adapted to the object and directed to points that are difficult to access, such as bends in pipes or corners of containers.

In a further embodiment, it is also possible to repair defects in glass or glass layers, since glass has properties similar to enamel layers. In a further embodiment, in the case of a coating, it is also possible to make engravings on glass in a targeted manner and to fuse them with the underlying glass layers.

To implement the invention, it is also expedient to combine the above-described configurations, embodiments, and features of the claims according to the invention in each arrangement.

### EMBODIMENT

The invention is to be explained in more detail below on the basis of an embodiment. The embodiment relates to the laser repair of enameled sheet metals and is intended to describe the invention without restricting it.

The invention is explained in more detail with reference to the drawings, in which:

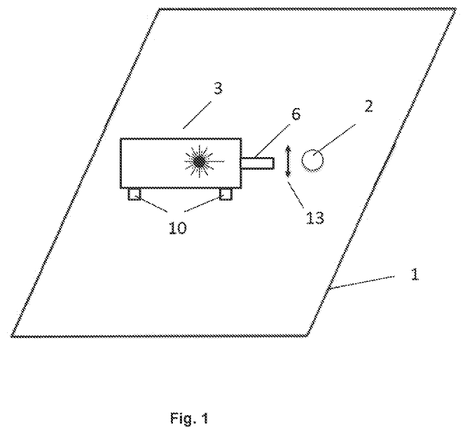

FIG. 1 is a schematic sketch, not to scale, of the laser repair system according to the invention, which laser repair system is placed in the vicinity of an exemplary defect in an enameled object,

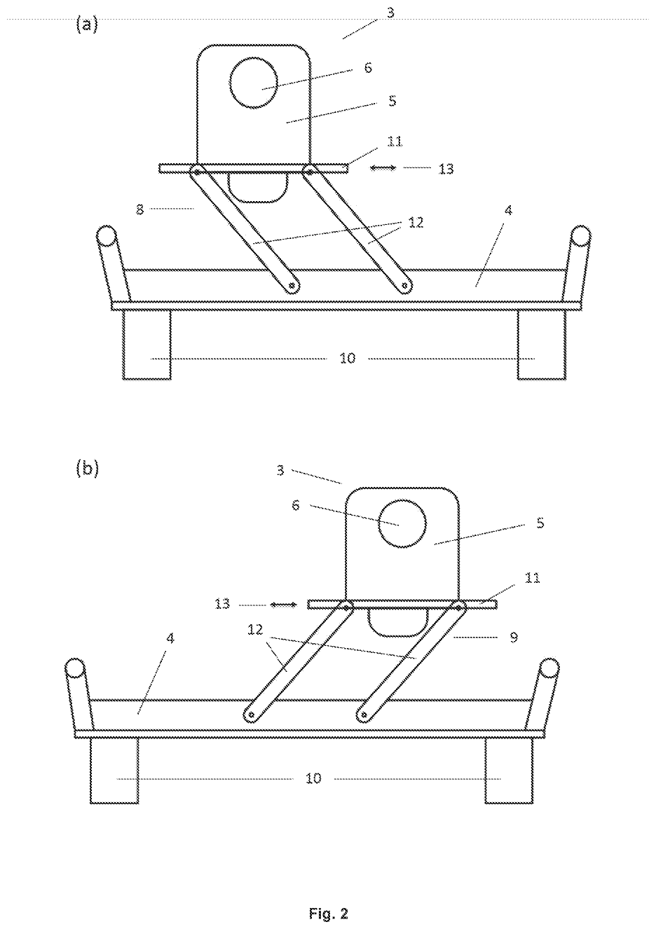

FIG. 2 shows the laser repair system according to the invention in a view from the front, with the pivoting device in the first position in FIG. 2a and the pivoting device in the second position in FIG. 2b,

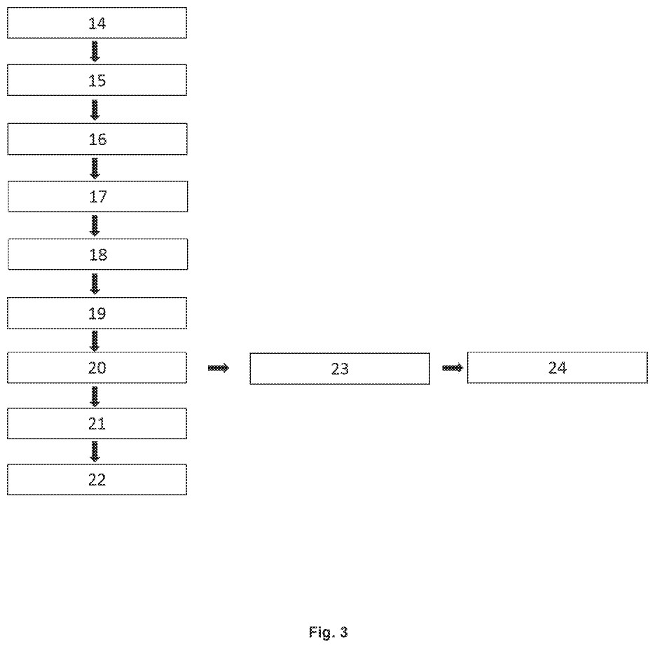

FIG. 3 is an overview scheme for the laser repair method according to the invention.

FIG. 1 shows a schematic sketch, not to scale, of the laser repair system 3 according to the invention, which laser repair system is placed in the vicinity of a defect 2 in an enameled object 1. The laser repair system 3 is arranged on the surface of the enameled object 1 by means of fastening means 10. The enameled object 1 is designed in the present case as an enameled silo sheet. The fastening means 10 are designed as magnetic feet. The laser machining head 6 is part of the heat irradiation device (not shown in the figure) and is directed at the defect 2. As a result of the arrangement on the platform of the pivoting device (not shown in the figure), the laser machining head 6 is designed to be movable in the xy direction along the horizontal dimension 13.

FIG. 2 shows the laser repair system 3 according to the invention, which laser repair system has a pivoting device 4 and a heat irradiation device 5, in a view from the front. The laser repair system 3 can be placed on the surface of an enameled object 1 such as, for example, an enameled silo plate (not shown in the figure) via two fastening means 10 designed as magnetic feet. The fastening means 10 are designed as electromagnets. Furthermore, the fastening means 10 are magnetic in the current-carrying state and can therefore be fixed on the surface of the enamel layer of the enameled object 1 and are non-magnetic in the de-energized state and thus designed so as to be detachable from the enamel layer of the enameled object 1. The pivoting device 4 also has a platform 11 with four pivoting arms 12 arranged thereon. By means of the pivoting arms 12, the platform 11 and the heat irradiation device 5 arranged thereon are designed to be movable in the xy direction along the horizontal dimension 13. The heat radiation device 5 mounted on the platform 11 of the pivoting device has a laser machining head 6 which is the interface of the laser (not shown in the figure) attached in the heat irradiation device 5 to the enameled object 1.

FIG. 2a shows the pivoting device 4 in the first position 8 which functions as a rest position. FIG. 2b shows the pivoting device 4 in the second position 9 which functions as a machining position.

FIG. 3 shows an overview diagram of the laser repair method according to the invention. First, the defect is detected 14. This is done using a high-voltage test.

Subsequently, the laser repair system according to the invention is placed on 15. This is done by means of the magnetic feet, which are attached to the underside of the pivoting device and placed on the surface of the enameled silo sheet. The electromagnets are energized and ensure that the laser repair system is fixed on the surface.

Subsequently, the alignment of the laser 16 takes place. For this purpose, the laser machining head is moved into the machining position. The alignment of the laser 16 takes place by suitable positioning of the laser machining head over the defect. Image recognition software and a camera system with crosshairs ensure the exact positioning and alignment of the laser machining head with the associated localization of the defect. This allows for mechanical fine positioning.

Subsequently, the pretreatment 17 takes place. For the mechanical and chemical pretreatment, the heat irradiation device is in the rest position. The mechanical pretreatment comprises milling the defect, the chemical pretreatment comprises etching the defect. Furthermore, the defect and the intact region around the defect are degreased. For the thermal pretreatment, the heat irradiation device is moved into the machining position. With the help of the laser beam from the laser machining head, contaminants are evaporated on the surface of the defect and the intact region around it.

The coating material is then applied 18 to the defect. The coating material is designed as a top enamel slip and completely fills the defect. The composition and properties of the top enamel slip correspond to the top enamel of the enameled silo sheet. The top enamel slip is brought into and onto the defect using a spray system. When the coating material is applied to the defect 18, the heat irradiation device is moved into the rest position. Excess top enamel slip, which protrudes above the surface of the enameled silo sheet, is removed with a blade. Subsequently, the drying of the top enamel slip takes place at approx. 80° C. to 100° C.

Subsequently, the baking process 19 of the top enamel slip takes place. For this purpose, the defect is irradiated with a laser beam from the laser machining head. For this purpose, the heat irradiation device is moved into the machining position. This is a Nd:YAG laser operated in a pulsed manner with a wavelength of 1064 nm, a laser power of 10 W to 20 W, and a pulse duration of 100 ns.

The check 20 of the treated, repaired defect is carried out subsequently. For this purpose, the heat irradiation device is moved back into the rest position. The check is again carried out via a high-voltage test. If the check is successful 21 in that a homogeneous layer has been restored and no formation of cracks occurred, the process is complete 22. One cycle of the repair method according to the invention was thus sufficient to repair the defect, i.e. coat it once and irradiate it once.

If the check is unsuccessful 23, the repair method according to the invention must be repeated 24. The coating and the irradiation can be repeated as often as desired, one after the other. This continues until the check is successful 21.

### REFERENCE SIGN

1 Enameled object
2 Defect
3 Laser repair system
4 Pivoting device
5 Heat irradiation device
6 Laser machining head
7 Laser beam
8 First position of the pivoting device
9 Second position of the pivoting device
10 Fastening means
11 Platform
12 Pivoting arm
13 Movement in the xy direction along the horizontal dimension
14 Detect the defect
15 Place on the laser repair system
16 Alignment of the laser
17 Pretreatment
18 Apply coating material
19 Baking process
20 Check
21 Check successful
22 Process completed
23 Check unsuccessful
24 Repeat repair method

1. A method for repairing at least one defect in a glass or glass-ceramic coating, wherein the glass or the glass-ceramic coating is arranged on a metallic or ceramic substrate, and for repairing defects on the metallic or ceramic substrate surface,
wherein the method comprises the following method steps:
applying enamel powder or enamel slip as a coating material to the at least one defect using a coating method,
removing excess coating material that protrudes,
drying applied coating material,
baking the applied coating material with heat input, said baking comprising the following steps:
a first focused, high-energy heat input by laser irradiation with an associated melting of a radiation spot,
a second defocused, low-energy heat input with controlled continuous cooling of the radiation spot, wherein the second defocused, low-energy heat input takes place by laser irradiation or inductively.

2. The method according to claim 1, wherein the method has at least one cycle, wherein individual method steps are applicable multiple times in succession.

3. The method according to claim 1, further comprising a detection of the at least one defect before the application of the coating material and/or a check of the at least one treated defect after the baking of the applied coating material, wherein the detection and/or check take(s) place by means of an optical and/or electrical test,
the visual test comprising a visual inspection, and
the electrical test comprising a high-voltage test in accordance with DIN EN 14430 or a low-voltage test in accordance with DIN EN ISO 8289.

4. The method according to claim 1, further comprising a mechanical and/or chemical and/or thermal pretreatment of the at least one defect.

5. The method according to claim 1, wherein the laser irradiation is carried out by a pulsed solid-state laser in the near infrared range from 780 nm to 3 μm, the solid-state laser being designed as an Nd:YAG laser with pulse durations between 9 ns and 250 ns and a laser power of 5 W to 200 W.

6. The method according to claim 1, wherein the heat input takes place through a laser repair system, the laser repair system being placed on the glass or the glass-ceramic coating before the coating material is applied and removed from the glass or the glass-ceramic coating after the baking.

7. The method according to claim 1, wherein the coating material has the same properties as the glass with the at least one defect or the glass-ceramic coating and is designed as an enamel slip or enamel powder with grain sizes of 0.35 to 160 μm.

8. The method according to claim 1, wherein the coating method is selected from a spraying method, a brushing method, a squeegee method, a casting method, a flooding method, a dipping method, a screen-printing method, and/or a spraying process.

9. A laser repair system for repairing defects according to claim 1, comprising at least one exchangeable pivoting device, an exchangeable heat irradiation device, and an energy supply unit, wherein:
the laser repair system is detachably arranged on the glass or the glass-ceramic coating,
the heat irradiation device is movably and detachably arranged on the pivoting device,
the heat irradiation device comprises at least one exchangeable laser machining head and at least one exchangeable laser,
the pivoting device has at least two positions for positioning the heat irradiation device, a first position corresponding to a rest position and a second position corresponding to a machining position on top of the defect.

10. The laser repair system according to claim 9, wherein the pivoting device has at least two pivoting arms on which a platform is arranged, the heat irradiation device being mounted on the platform and the platform being designed to be movable by the pivoting arms in the xy direction along the horizontal dimension relative to the enameled object between the first and the second position.

11. The laser repair system according to claim 9, wherein the laser repair system is detachably arranged on the glass or the glass-ceramic coating by at least one fastening means attached to the underside of the pivoting device, the underside of the pivoting device pointing towards the glass or the glass-ceramic coating.

12. The laser repair system according to claim 9, further comprising a coating system and/or a pretreatment device and/or a detection system.

13. The laser repair system according to claim 9, wherein, during the application of the coating material to the at least one defect and/or the removal of protruding excess coating material and/or the drying of the coating material and/or the detection and/or check and/or the pretreatment by a laser, the laser machining head is aligned in the first position of the pivoting device and, during the baking of the applied coating material with the heat input and/or the thermal pretreatment, is aligned in the second position of the pivoting device.

14. A method for repairing defects in a substrate selected from a container or storage facility, cladding of room, pipe, sign, industrial part, consumer good, cooking vessel, apparatus, and panel in tunnels or subways, said method comprising performing on the substrate the method for repairing at least one defect in a glass or glass-ceramic coating according to claim 1.

15. The method according to claim 2, further comprising a detection of the at least one defect before the application of the coating material and/or a check of the at least one treated defect after the baking of the applied coating material, wherein the detection and/or check take(s) place by means of an optical and/or electrical test,
the visual test comprising a visual inspection, and
the electrical test comprising a high-voltage test in accordance with DIN EN 14430 or a low-voltage test in accordance with DIN EN ISO 8289.

16. The method according to claim 15, further comprising a mechanical and/or chemical and/or thermal pretreatment of the at least one defect.

17. The method according to claim 15, wherein the laser irradiation is carried out by a pulsed solid-state laser in the near infrared range from 780 nm to 3 μm, the solid-state laser being designed as an Nd:YAG laser with pulse durations between 9 ns and 250 ns and a laser power of 5 W to 200 W.

18. The method according to claim 15, wherein the heat input takes place through a laser repair system, the laser repair system being placed on the glass or the glass-ceramic coating before the coating material is applied and removed from the glass or the glass-ceramic coating after the baking.

19. The method according to claim 15, wherein the coating material has the same properties as the glass with the at least one defect or the glass-ceramic coating and is designed as an enamel slip or enamel powder with grain sizes of 0.35 to 160 μm.

20. The method according to claim 15, wherein the coating method is selected from a spraying method, a brushing method, a squeegee method, a casting method, a flooding method, a dipping method, a screen-printing method, and/or a spraying process.
